(19) United States
(12) Patent Application Publication
(10) Pub. No.: US 2008/0290636 A1
(43) Pub. Date: Nov. 27, 2008

(54) Device for Triggering Personal Protective Means

(76) Inventors: Alfred Kuttenberger, Hamburg (DE); Matthias Wellhoefer, Stuttgart (DE)

Correspondence Address: KENYON & KENYON LLP, ONE BROADWAY, NEW YORK, NY, 10004, US

(21) Appl. No.: 10/594,356

(22) PCT Filed: Jan. 25, 2005
(86) PCT No.: PCT/EP2005/050302

§ 371 Date: Aug. 4, 2008

(30) Foreign Application Priority Data
Mar. 27, 2004 (DE) 102004015125.3

(51) Int. Cl. B60R 21/0132; B60R 21/01

(52) U.S. Cl. 280/735

(57) ABSTRACT

A device for triggering personal protective means in a vehicle, an inertial sensor system being provided in a first location, a processor being provided in a second location, and a firing circuit control being provided in a third location in the vehicle. The processor processes the signals of the inertial sensor system and as a function of this triggers the firing circuit control.

### BACKGROUND INFORMATION

It is already known that there are devices for triggering personal protective means such as airbags, belt tensioners or roll bars.

### SUMMARY OF THE INVENTION

The device according to the present invention for triggering personal protective means in a vehicle has the advantage that the inertial sensor system, the processor and the firing circuit control are each situated in different locations in the vehicle. These locations are so different that they are not situated in proximity to each other. This has the advantage that the processor with its peripherals, which makes up the control unit, but this time without sensory system, may be freely placed in the vehicle without having to deal with the need for the inertial sensor system. In particular, it is no longer necessary to position the control unit on the vehicle tunnel, where now only the inertial sensory system still needs to be placed. The inertial sensory system includes acceleration sensors in different spatial directions, which may be arranged in the longitudinal, lateral and vertical directions of the vehicle, but also at an angle with respect to these axes. Furthermore, the inertial sensor system includes a detection of rotary motions such as rotational acceleration sensors or rotation-rate sensors. It is also possible, however, that the inertial sensor system is distributed in the periphery of the vehicle, the periphery including A-, B-, C-pillars, the radiator grille, etc. The inertial sensory system may also be mounted centrally on a front wall, for example, the partition wall between the engine compartment and the passenger compartment. The advantage is that on the one hand the sensors are mounted in the extension of the longitudinal vehicle axis and even detect higher signals since they are closer to the crash event if the crash event is a frontal collision.

It is particularly advantageous that the location at which the inertial sensory system is situated is the vehicle tunnel or the B-pillars. Both are locations that allow for optimal sensing. A very central position is provided on the vehicle tunnel, while the B-pillars are in proximity to a side crash event, it being here in particular also possible, however, to detect a frontal crash if sensors are used as well that sense not only in the lateral direction of the vehicle but also in the longitudinal direction of the vehicle. This may also be supplemented by upfront sensors, that is, sensors that are mounted on the radiator grille at the front of the vehicle. The location where the processor and also the firing circuit system are positioned may be the trunk, the dashboard, underneath a vehicle seat or in a vehicle seat, the roof of the vehicle or the engine compartment. The processor may preferably be mounted on a plug-in card, thus allowing for simple replacement during a servicing cycle. The processor may furthermore be advantageously a central computer for the vehicle, which in addition to triggering personal protection means also takes care of other tasks such as comfort functions or other vehicle systems such as braking systems. The processor may be connected to an inertial sensor system and also to the firing circuit control in each case via a bus. Alternatively, it is also possible to use two-wire connections representing point-to-point connections.

Furthermore, it is advantageous that the inertial sensor system has a signal pre-evaluation. This signal pre-evaluation already relieves the processor of some tasks, thus accelerating the execution in the processor. Such signal preprocessing tasks are e.g. filtering, clipping, integration, derivations, normalizations or other conversions. The signal preprocessing may also perform an intelligent data reduction. For this purpose, a simple processor could be assigned to the inertial sensor system, which determines these variables.

### BRIEF DESCRIPTION OF THE DRAWINGS

FIG. 1 shows a block diagram of the device according to the present invention.

FIG. 2 shows a top view in a vehicle.

### DETAILED DESCRIPTION

Airbag control devices usually have an inertial sensor system, that is, acceleration sensors and possibly also sensors for detecting a rotary motion, and are therefore usually mounted on the vehicle tunnel. Additionally, peripheral acceleration sensors may also be provided.

The present invention provides for the control device no longer to have sensors. These sensors are then installed separately in the vehicle. For this purpose, they may be implemented either in individual, separate housings or also as a functional cluster. This reduces the installation requirement placed on the control device containing the processor in such a way that the installation location may now be freely chosen since the space on the central vehicle tunnel is severely limited and expensive.

The now separated sensor system is connected to the now freely installable airbag control device. The inertial sensor system, for example, has two or three sensor elements in order to detect accelerations in the X (longitudinal vehicle direction), Y (lateral vehicle direction) and Z direction (vertical vehicle direction). In this connection there is the option of arranging the sensor at an angle e.g. at 45° with respect to the longitudinal vehicle axis so as thereby to achieve a better detection of angle crashes. For a rollover module, for example, a YZ acceleration sensor for low accelerations together with a rotation-rate sensor is integrated into a housing.

Depending on the requirements, the sensor module or sensor modules sit(s) on the tunnel if this is necessary or also in another location. These can be shifted within the framework of their requirements, e.g. a rotation-rate sensor should only lie in the XY plane. Thus there exists only an angle requirement. It does not have to be situated on the tunnel. An acceleration sensor in the longitudinal vehicle direction may be shifted on the tunnel on the X axis. As an alternative to a central XY acceleration sensor on the vehicle tunnel, a system made up of two peripheral XY acceleration sensors in the B-pillars, for example, may also be used. This has the advantage that, in addition to a side sensing, a better offset detection in a frontal crash and a better detection of angle crashes may also be achieved, it being at the same time possible to design the tunnel free of the airbag sensor system.

As another specific embodiment, the entire central acceleration sensor system may also be separated and mounted in a sensor cluster centrally on the front wall (partition wall between engine compartment and passenger compartment). The advantage here is that on the one hand the sensors are attached in the extension of the X axis or the tunnel and even detect higher signals since they are closer to the crash event. As an interface to the processor, an already existing two-wire interface may be used, for example, although other interfaces are also conceivable. BUS systems, for example, represent such alternatives. In this manner, several sensors as well as actuators may be connected together. It is also conceivable that other control devices can access the sensor information and use it for other functions. This includes vehicle dynamics controls, for example.

In another step it is also conceivable to integrate into the sensor module a rotation-rate sensor or an acceleration sensor in the longitudinal vehicle direction for plausibilization so as to keep the airbag control device free of sensors.

The sensor modules send their measurement data via the interface to the control device or processor. In the process, a signal preprocessing such as e.g. filtering, clipping, that is, a clipping of amplitudes, integration of a derivation, normalizations, conversions etc. may be already performed in the sensor modules. If it is a more complex model having two or more sensor elements, then an intelligent data reduction may also be performed in the module itself. A small processor in the sensor module calculates in each case only the crash-relevant variables and transmits only these to the control device or processor.

The control device without sensors may be installed in the vehicle in any desired location. Examples for this are the trunk, the dashboard, a place under the rear seat bench or under the front seats, in the roof, in the engine compartment or in the seat. Another specific embodiment of the control device without sensor system is an insertion module, that is, a plug-in module, which can be installed into standardized card slots. This has the advantage that a simple update may be performed in the workshop by replacing the plug-in module by the newer version. For this purpose, 9-inch racks may be used, for example.

In another specific embodiment, the control device is reduced to a firing module that represents the hardware for triggering the airbag. The entire software including the triggering algorithm is located either in another control device or in a central vehicle computer. Alternatively, the central vehicle computer has at least one BUS system designed for a safety system. Via this BUS system, control commands are transmitted to the firing module having an integrated intelligence as well as directly to reversible restraint means such as belt tensioners or head rests. A great advantage of the central computer in the vehicle is that this system has access to all system information from different subsystems without requiring a complicated networking of different control devices.

Advantageously, the present invention allows for the sensor module to be designed small, thus making it readily installable in tight spatial conditions such as the central tunnel. Furthermore, due to its compactness, the sensor module can be connected better to the vehicle structure and is thus better suited to pick up the decelerations more quickly. Furthermore, the compact design of the sensor module has the result that it is decoupled from the printed circuit board of the control device and consequently no transmission of printed circuit board oscillations to the sensor is possible. The processor, which represents the control device, may moreover also be installed at other locations in the vehicle where space is available, e.g., as indicated above, under the seat or in the trunk, since the space on the vehicle tunnel is very expensive. Furthermore, in the event of a defect in the airbag control device, the replacement is easier since e.g. the trunk is relatively easily accessible.

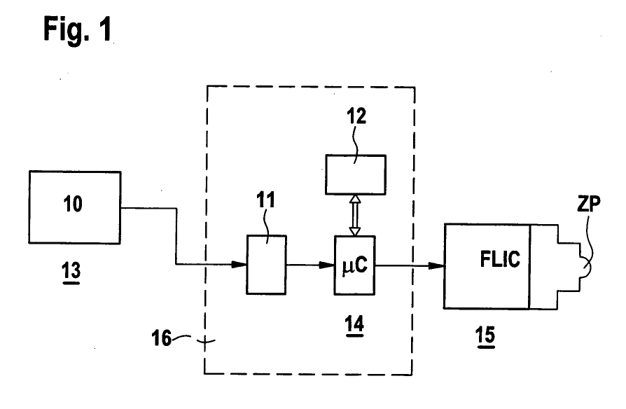

FIG. 1 shows the device according to the present invention in a block diagram. An inertial sensor system 10 is located on the vehicle tunnel 13. Inertial sensor system 10 is connected to an interface module 11, which is an element of a control unit 16 for triggering personal protective means and is situated in a location 14, which is the trunk. Interface module 11 transmits the data from inertial sensor system 10 to a processor μC, which is connected via a data input/output to a memory 12 in order to process the data. Processor μC is connected via a data output to a firing circuit control FLIC situated at location 15, for example, in the dashboard. In the event of a firing, firing circuit control FLIC results in a supply of current to firing element ZP, the firing of which then results in the inflation of an airbag, for example. For the sake of simplicity, only individual elements are shown here and also in control device 16 elements are missing such as, for example, a safety semiconductor for the parallel monitoring of the sensor values of processor μC. Other sensor systems as well such as a passenger compartment sensor system or a precrash sensor system have been omitted here for the sake of simplicity, but may be added in a simple manner. This distribution of the elements to different locations allows for an extremely flexible placement of these components.

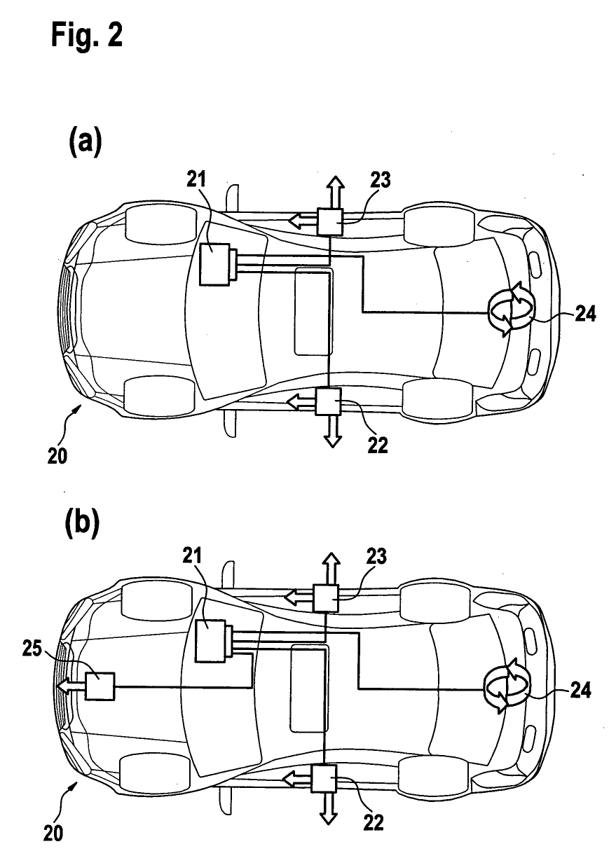

FIGS. 2a and 2b show examples of such embodiments. FIG. 2a shows a configuration in a vehicle, in which a control device 21 without sensors is connected respectively to XY sensors in B-pillars 22 and 23 and also to a sensor 24 for detecting a rotary motion, for example, about the longitudinal vehicle axis in order to detect a so-called rollover. The firing circuit control may be situated in control unit 21 or also in other locations such as a vehicle seat, for example.

FIG. 2b shows an alternative, identical elements being indicated by the same reference symbols. In addition to control device 21, the two XY sensors 22 and 23 in the B-pillars, and sensor 24 for detecting the rotary motion, for example, a rotation-rate sensor, here now also an upfront sensor 25 is provided at the front of the vehicle, which allows for a rapid detection of a frontal crash.

1-7. (canceled)

8. A device for triggering a personal protection device in a vehicle, comprising:
an inertial sensor system situated in a first location in the vehicle;
a processor for evaluating a signal of the inertial sensor system situated in a second location in the vehicle; and
a firing circuit control, which is triggered as a function of a second signal of the processor, situated in a third location in the vehicle.

9. The device according to claim 8, wherein the first location is one of (a) a vehicle tunnel and (b) B-pillars.

10. The device according to claim 8, wherein at least one of the second location and the third location is one of the following: a trunk, a dashboard, under a vehicle seat, in a vehicle seat, a vehicle roof, and an engine compartment.

11. The device according to claim 8, wherein the processor is a central computer for the vehicle.

12. The device according to claim 8, wherein the inertial sensor system has a sensor signal pre-evaluation.

13. The device according to claim 8, wherein the inertial sensor system is connected to the processor and to the firing circuit control in each case via a BUS system.

14. The device according to claim 8, wherein the processor is situated on a plug-in module.
